(19) United States
(12) Patent Application Publication
(10) Pub. No.: US 2020/0369296 A1
(43) Pub. Date: Nov. 26, 2020

(54) AUTONOMOUS DRIVING APPARATUS AND METHOD

(71) Applicant: Hyundai Mobis Co., Ltd, Seoul (KR)

(72) Inventors: Jae Yoon KIM, Yongin-si (KR); Jun Han LEE, Yongin-si (KR)

(21) Appl. No.: 16/877,411

(22) Filed: May 18, 2020

(30) Foreign Application Priority Data
May 20, 2019 (KR) 10-2019-0058608

(51) Int. Cl. B60W 60/00; B60W 30/095

(52) U.S. Cl. CPC B60W 60/0025; B60W 30/095; B60W 2554/40; B60W 2420/42; B60W 2552/00; B60W 2420/52

(57) ABSTRACT

An autonomous driving apparatus including a sensor unit, a memory, and a processor. The processor is configured to extract one or more valid measurement values within the validation gate of an estimate of the location of a target object, generated based on a measurement value of the location, among one or more measurement values output by the sensor unit, to form a track of the target object by taking into consideration a probability that each of the extracted valid measurement values corresponds to a measurement value of the location of the target object at a current timing, to track the target object using the track, and to extract the valid measurement values by adjusting the size of the validation gate based on time period during which the tracking of the target object is maintained and surrounding environment information of an ego vehicle being autonomously driven.

### CROSS-REFERENCE TO RELATED APPLICATION

This application claims priority from and the benefit of Korean Patent Application No. 10-2019-0058608, filed on May 20, 2019, which is hereby incorporated by reference for all purposes as if set forth herein.

### BACKGROUND

### Field

Exemplary embodiments of the present disclosure relate to an autonomous driving apparatus and method applied to an autonomous vehicle.

### Discussion of the Background

Today's automobile industry is moving towards an implementation of autonomous driving to minimize the intervention of a driver in vehicle driving. An autonomous vehicle refers to a vehicle that autonomously determines a driving path by recognizing a surrounding environment using an external information detection and processing function upon driving and independently travels using its own motive power.

The autonomous vehicle can autonomously travel up to a destination while preventing a collision against an obstacle on a driving path and controlling a vehicle speed and driving direction based on a shape of a road although a driver does not manipulate a steering wheel, an acceleration pedal or a brake. For example, the autonomous vehicle may perform acceleration in a straight road, and may perform deceleration while changing a driving direction in accordance with the curvature of a curved road in the curved road.

In order to guarantee the safe driving of an autonomous vehicle, the driving of the autonomous vehicle needs to be controlled based on a measured driving environment by precisely measuring the driving environment using sensors mounted on the vehicle and continuing to monitor the driving state of the vehicle. To this end, various sensors such as a LIDAR sensor, a radar sensor, an ultrasonic sensor, and a camera sensor, that is, sensors for detecting surrounding objects such as surrounding vehicles, pedestrians and fixed facilities, are applied to the autonomous vehicle. Data output by such a sensor is used to determine information on a driving environment, for example, state information such as a location, shape, moving direction and moving speed of a surrounding object.

Furthermore, the autonomous vehicle also has a function for optimally determining a driving path and driving lane by determining and correcting the location of the vehicle using previously stored map data, controlling the driving of the vehicle so that the vehicle does not deviate from the determined path and lane, and performing defense and evasion driving for a risk factor in a driving path or a vehicle that suddenly appears nearby.

Background of the Disclosure is disclosed in Korean Patent Application Laid-Open No. 10-1998-0068399 (Oct. 15, 1998).

The above information disclosed in this Background section is only for enhancement of understanding of the background of the invention and, therefore, it may contain information that does not constitute prior art.

### SUMMARY

Exemplary embodiments of the present invention provide an autonomous vehicle adopts a target detection function for detecting a surrounding object using a LIDAR sensor, a radar sensor, or a camera sensor and generating an alarm to notify a driver of the presence of an obstacle, or stopping the vehicle before the vehicle collides against an obstacle or traveling by avoiding the obstacle by controlling the driving system of the vehicle.

If a surrounding object is detected using a camera sensor, an image of the object is directly captured, so that whether the object in the captured image is an obstacle to be avoided can be easily determined. However, there are problems in that a distance within which an image may be taken to the extent that an obstacle can be identified is limited due to resolution of a screen and a field of vision and it is difficult to measure a distance from an object based on an image only.

The LIDAR sensor or the radar sensor has an advantage in that it can detect an object at a relatively long distance, but has problems in that it is not easy to determine whether a detected object is an obstacle to be avoided or noise because the sensor does not directly detect an image of the object and is easily influenced by noise and that a target is omitted because the sensor does not track a movement of a surrounding object when tracking the movement of the object.

Various embodiments of the present invention are related to the provision of an autonomous driving apparatus and method capable of accurately identifying and tracking a target object, that is, a target to be detected, among surrounding objects detected using a sensor mounted on an autonomous vehicle.

An exemplary embodiment of the present invention provides an autonomous driving apparatus including a sensor unit configured to detect a target object around an ego vehicle being autonomously driven, a memory configured to store map information, and a processor configured to control autonomous driving of the ego vehicle being autonomously driven, based on the map information stored in the memory and a track indicative of a state trajectory of the target object estimated based on a measurement value of a location of the target object detected by the sensor unit. The processor is configured to extract one or more valid measurement values within a validation gate of an estimate of the location of the target object, generated based on the measurement value of the location, among one or more measurement values output by the sensor unit, form a track of the target object by taking into consideration a probability that each of the extracted valid measurement values corresponds to a measurement value of the location of the target object at a current timing and track the target object using the track, and extract the valid measurement values by adjusting a size of the validation gate based on time period during which the tracking of the target object is maintained and surrounding environment information of the ego vehicle being autonomously driven.

The processor may be configured to determine whether a Mahalanobis distance determined based on an innovation between the measurement value and the estimate of the location of the target object and covariance of the innovation is less than a threshold to determine the size of the validation gate and to extract the valid measurement values.

The processor may be configured to decrease the size of the validation gate by reducing the threshold according to an increase in the time period during which the tracking of the target object is maintained.

The processor may be configured to increase or decrease the size of the validation gate by adjusting the threshold using an environment weight into which a degree of tracking caution based on the surrounding environment information has been incorporated. The surrounding environment information may include at least one of a shape, attributes, traffic condition, and road surface condition of a front road.

The processor may be configured to update the track using a method of updating the estimate of the location of the target object over time, store, in the memory, a history in which the track is updated, and perform track management through an initialization of the track.

The sensor unit may include at least one of a LIDAR sensor, a radar sensor, and a camera sensor.

Another exemplary embodiment of the invention provides an autonomous driving method of controlling the autonomous driving of an ego vehicle being autonomously driven by a processor based on map information stored in a memory and a track indicative of a state trajectory of a target object around the ego vehicle being autonomously driven, estimated based on a measurement value of a location of the target object detected by a sensor unit. The method includes extracting, by the processor, one or more valid measurement values within a validation gate of an estimate of the location of the target object, generated based on the measurement value of the location, among one or more measurement values output by the sensor unit, and forming, by the processor, a track of the target object by taking into consideration a probability that each of the extracted valid measurement values corresponds to a measurement value of the location of the target object at a current timing and tracking the target object using the track. In the extracting of the one or more valid measurement values, the processor extracts the valid measurement values by adjusting a size of the validation gate based on time period during which the tracking of the target object is maintained and surrounding environment information of the ego vehicle being autonomously driven. It is to be understood that both the foregoing general description and the following detailed description are exemplary and are intended to provide further explanation of the invention as claimed/

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a general block diagram of an autonomous driving control system to which an autonomous driving apparatus according to an exemplary embodiment of the present invention may be applied.

FIG. 2 is a block diagram illustrating a detailed configuration of an autonomous driving integrated controller in the autonomous driving apparatus according to an exemplary embodiment of the present invention.

FIG. 3 is an exemplary diagram illustrating an example in which the autonomous driving apparatus according to an exemplary embodiment of the present invention is applied to a vehicle.

FIG. 4 is an exemplary diagram illustrating an example of an internal structure of a vehicle to which the autonomous driving apparatus according to an exemplary embodiment of the present invention is applied.

FIG. 5 is an exemplary diagram illustrating an example of a set distance and horizontal field of view within which a LIDAR sensor, a radar sensor, and a camera sensor may detect a surrounding object in the autonomous driving apparatus according to an exemplary embodiment of the present invention.

FIG. 6 is an exemplary diagram illustrating an example in which a sensor unit detects a surrounding vehicle in the autonomous driving apparatus according to an exemplary embodiment of the present invention.

FIG. 7 is a flowchart for describing an autonomous driving method according to an exemplary embodiment of the present invention

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

Hereinafter, an autonomous driving apparatus and method will be described below with reference to the accompanying drawings through various exemplary embodiments. The thickness of lines or the size of elements shown in the drawings in this process may have been exaggerated for the clarity of a description and for convenience' sake. Terms to be described below have been defined by taking into consideration their functions in the disclosure, and may be changed depending on a user or operator's intention or practice. Accordingly, such terms should be interpreted based on the overall contents of this specification.

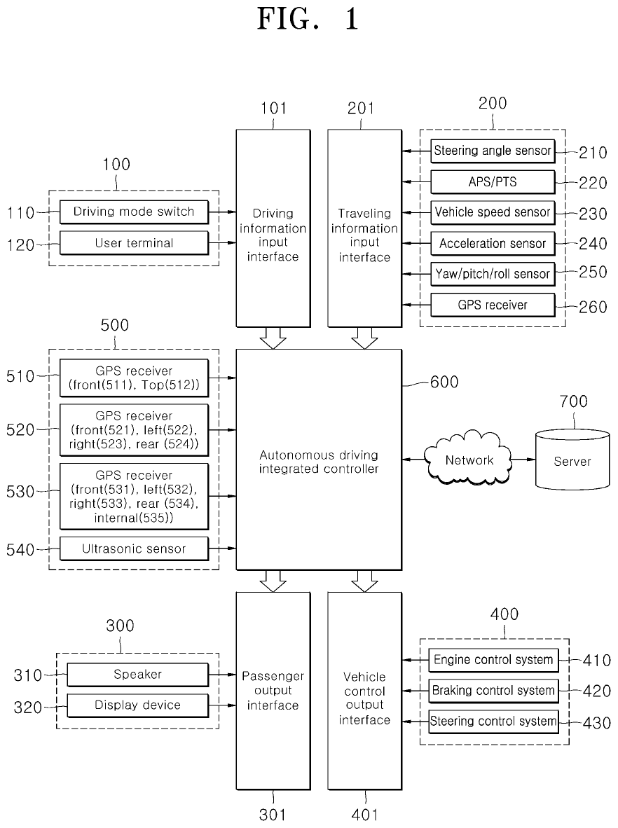

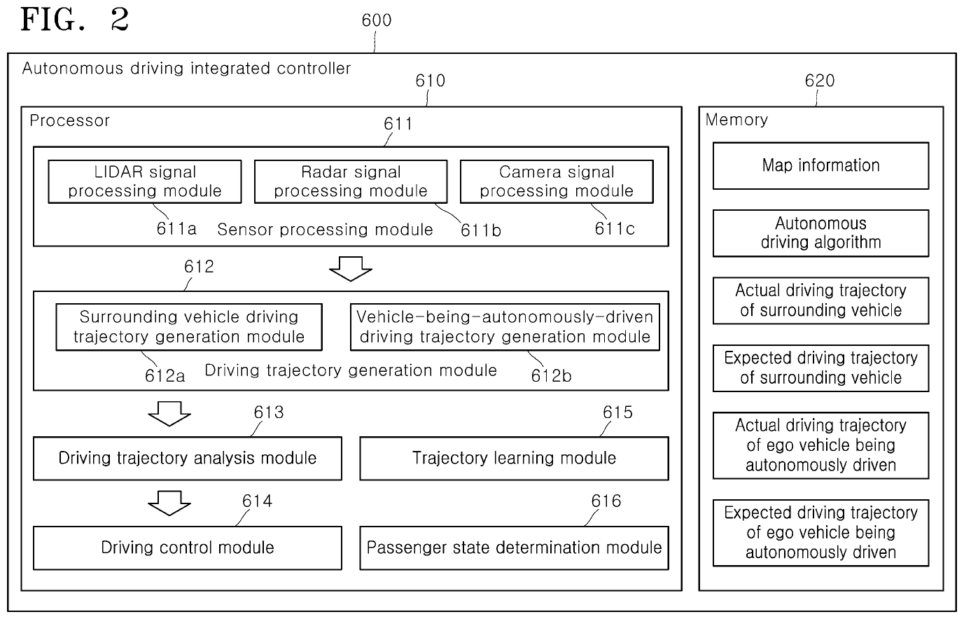

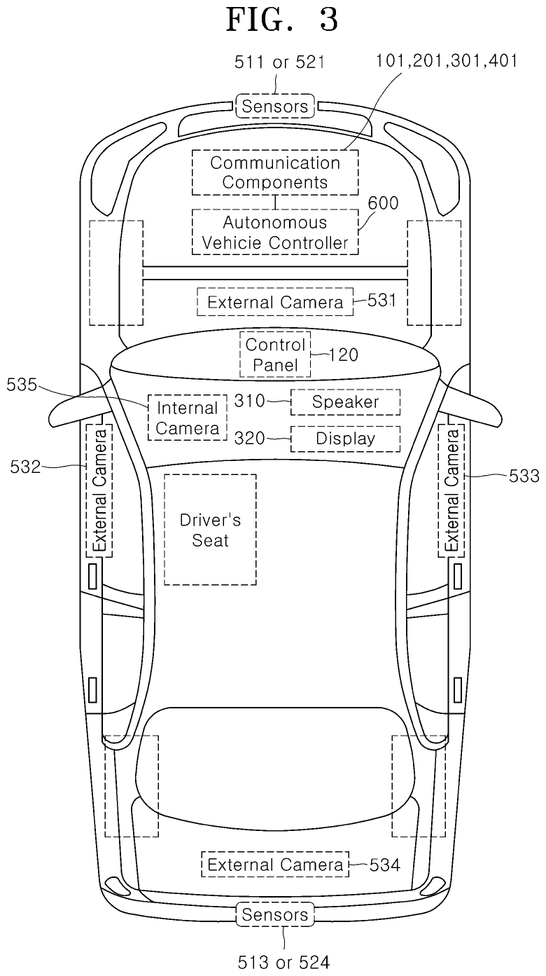

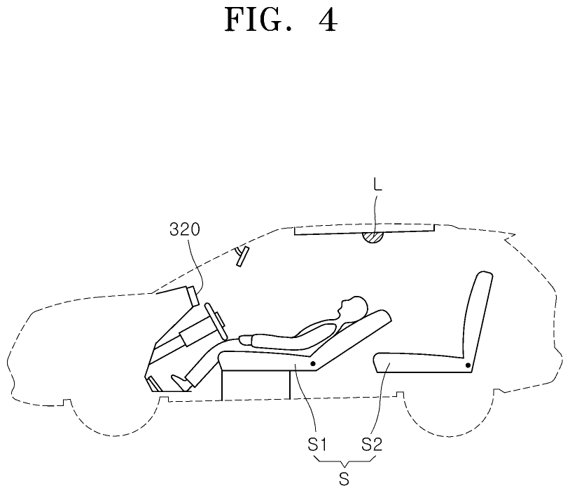

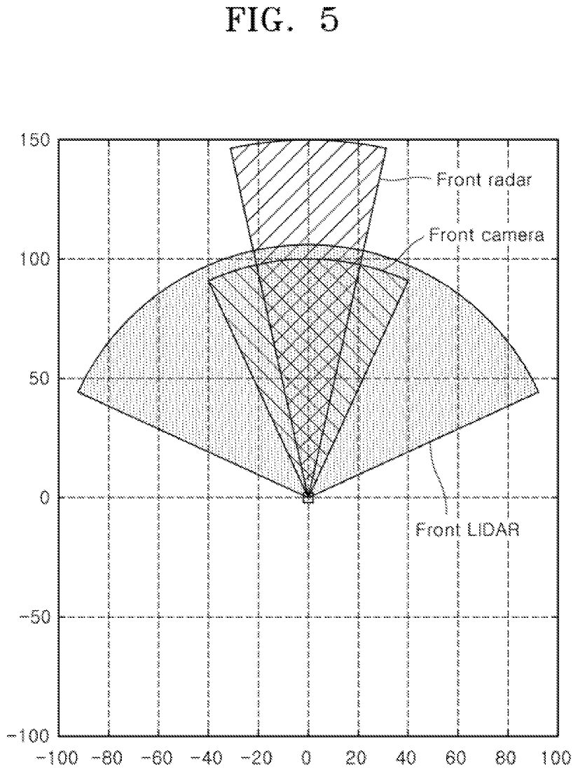

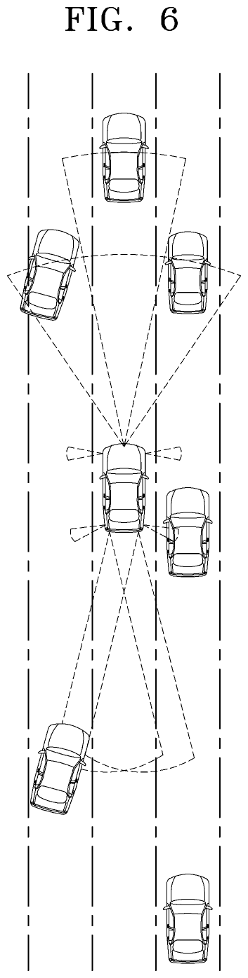

FIG. 1 is a general block diagram of an autonomous driving control system to which an autonomous driving apparatus according to an exemplary embodiment of the present invention may be applied. FIG. 2 is a block diagram illustrating a detailed configuration of an autonomous driving integrated controller in the autonomous driving apparatus according to an exemplary embodiment of the present invention. FIG. 3 is an exemplary diagram illustrating an example in which the autonomous driving apparatus according to an exemplary embodiment of the present invention is applied to a vehicle. FIG. 4 is an exemplary diagram illustrating an example of an internal structure of a vehicle to which the autonomous driving apparatus according to an exemplary embodiment of the present invention is applied. FIG. 5 is an exemplary diagram illustrating an example of a set distance and horizontal field of view within which a LIDAR sensor, a radar sensor, and a camera sensor may detect a surrounding object in the autonomous driving apparatus according to an exemplary embodiment of the present invention. FIG. 6 is an exemplary diagram illustrating an example in which a sensor unit detects a surrounding vehicle in the autonomous driving apparatus according to an exemplary embodiment of the present invention.

First, the structure and functions of an autonomous driving control system to which an autonomous driving apparatus according to the present embodiment may be applied are described with reference to FIGS. 1 and 3. As illustrated in FIG. 1, the autonomous driving control system may be implemented based on an autonomous driving integrated controller 600 configured to transmit and receive data necessary for autonomous driving control of a vehicle through a driving information input interface 101, a traveling information input interface 201, a passenger output interface 301 and a vehicle control output interface 401.

The autonomous driving integrated controller 600 may obtain, through the driving information input interface 101, driving information based on a manipulation of a passenger for a user input unit 100 in an autonomous driving mode or manual driving mode of a vehicle. As illustrated in FIG. 1, the user input unit 100 may include a driving mode switch 110 and a user terminal 120 (e.g., a navigation terminal mounted on a vehicle or a smartphone or tablet PC owned by a passenger), for example. Accordingly, driving information may include driving mode information and navigation information of a vehicle. For example, a driving mode (i.e., an autonomous driving mode/manual driving mode or a sport mode/eco mode/safe mode/normal mode) of a vehicle determined by a manipulation of a passenger for the driving mode switch 110 may be transmitted to the autonomous driving integrated controller 600 through the driving information input interface 101 as the driving information. Furthermore, navigation information, such as the destination of a passenger and a path up to the destination (e.g., the shortest path or preference path, selected by the passenger, among candidate paths up to the destination) input by a passenger through the user terminal 120, may be transmitted to the autonomous driving integrated controller 600 through the driving information input interface 101 as the driving information. The user terminal 120 may be implemented as a control panel (e.g., touch screen panel) that provides a user interface (UI) through which a driver inputs or modifies information for autonomous driving control of a vehicle. In this case, the driving mode switch 110 may be implemented as a touch button on the user terminal 120.

Furthermore, the autonomous driving integrated controller 600 may obtain traveling information indicative of a driving state of a vehicle through the traveling information input interface 201. The traveling information may include a steering angle formed when a passenger manipulates a steering wheel, an acceleration pedal stroke or brake pedal stroke formed when an acceleration pedal or brake pedal is stepped on, and various types of information indicative of driving states and behaviors of a vehicle, such as a vehicle speed, acceleration, a yaw, a pitch and a roll, that is, behaviors formed in the vehicle. The pieces of traveling information may be detected by a traveling information detection unit 200, including a steering angle sensor 210, an accel position sensor (APS)/pedal travel sensor (PTS) 220, a vehicle speed sensor 230, an acceleration sensor 240, and a yaw/pitch/roll sensor 250, as illustrated in FIG. 1. Furthermore, the traveling information of a vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201, and may be used to control the driving of a vehicle in the autonomous driving mode or manual driving mode of the vehicle.

Furthermore, the autonomous driving integrated controller 600 may transmit, to an output unit 300, driving state information, provided to a passenger, through the passenger output interface 301 in the autonomous driving mode or manual driving mode of a vehicle. That is, the autonomous driving integrated controller 600 transmits driving state information of a vehicle to the output unit 300 so that a passenger can check the autonomous driving state or manual driving state of the vehicle based on the driving state information output through the output unit 300. The driving state information may include various types of information indicative of driving states of a vehicle, such as a current driving mode, transmission range and vehicle speed of the vehicle, for example. Furthermore, if it is determined that it is necessary to warn a driver in the autonomous driving mode or manual driving mode of a vehicle along with the driving state information, the autonomous driving integrated controller 600 transmits warning information to the output unit 300 through the passenger output interface 301 so that the output unit 300 can output a warning to the driver. In order to output such driving state information and warning information acoustically and visually, the output unit 300 may include a speaker 310 and a display 320 as illustrated in FIG. 1. In this case, the display 320 may be implemented as the same device as the user terminal 120 or may be implemented as an independent device separated from the user terminal 120.

Furthermore, the autonomous driving integrated controller 600 may transmit control information for driving control of a vehicle to a low-ranking control system 400, applied to a vehicle, through the vehicle control output interface 401 in the autonomous driving mode or manual driving mode of the vehicle. As illustrated in FIG. 1, the low-ranking control system 400 for driving control of a vehicle may include an engine control system 410, a braking control system 420 and a steering control system 430. The autonomous driving integrated controller 600 may transmit engine control information, braking control information and steering control information, as the control information, to the respective low-ranking control systems 410, 420 and 430 through the vehicle control output interface 401. Accordingly, the engine control system 410 may control the vehicle speed and acceleration of a vehicle by increasing or decreasing fuel supplied to an engine. The braking control system 420 may control the braking of the vehicle by controlling braking power of the vehicle. The steering control system 430 may control the steering of the vehicle through a steering apparatus (e.g., motor driven power steering (MDPS) system) applied to the vehicle.

As described above, the autonomous driving integrated controller 600 according to the present embodiment may obtain driving information based on a manipulation of a driver and traveling information indicative of a driving state of a vehicle through the driving information input interface 101 and the traveling information input interface 201, respectively, may transmit, to the output unit 300, driving state information and warning information, generated based on an autonomous driving algorithm processed by a processor 610 therein, through the passenger output interface 301, and may transmit, to the low-ranking control system 400, control information, generated based on the autonomous driving algorithm processed by the processor 610, through the vehicle control output interface 401 so that driving control of the vehicle is performed.

In order to guarantee stable autonomous driving of a vehicle, it is necessary to continuously monitor a driving state of the vehicle by accurately measuring a driving environment of the vehicle and to control driving based on the measured driving environment. To this end, as illustrated in FIG. 1, the autonomous driving apparatus according to the present embodiment may include a sensor unit 500 for detecting a surrounding object of a vehicle, such as a surrounding vehicle, pedestrian, road or fixed facility (e.g., a signal light, a signpost, a traffic sign or a construction fence). The sensor unit 500 may include one or more of a LIDAR sensor 510, a radar sensor 520 and a camera sensor 530 in order to detect a surrounding object outside a vehicle, as illustrated in FIG. 1.

The LIDAR sensor 510 may transmit a laser signal to the periphery of a vehicle, and may detect a surrounding object outside the vehicle by receiving a signal reflected and returned from a corresponding object. The LIDAR sensor 510 may detect a surrounding object located within a set distance, set vertical field of view and set horizontal field of view, which are predefined depending on its specifications. The LIDAR sensor 510 may include a front LIDAR sensor 511, a top LIDAR sensor 512 and a rear LIDAR sensor 513 installed at the front, top and rear of a vehicle, respectively, but the installation location of each sensor and the number of sensors installed are not limited to a specific embodiment. A threshold for determining the validity of a laser signal reflected and returned from a corresponding object may be previously stored in a memory 620 of the autonomous driving integrated controller 600. The processor 610 of the autonomous driving integrated controller 600 may determine a location (including a distance to a corresponding object), speed and moving direction of the corresponding object using a method of measuring the time taken for a laser signal, transmitted through the LIDAR sensor 510, to be reflected and returned from the corresponding object.

The radar sensor 520 may radiate electromagnetic waves around a vehicle, and may detect a surrounding object outside the vehicle by receiving a signal reflected and returned from a corresponding object. The radar sensor 520 may detect a surrounding object within a set distance, set vertical field of view and set horizontal field of view, which are predefined depending on its specifications. The radar sensor 520 may include a front radar sensor 521, a left radar sensor 522, a right radar sensor 523 and a rear radar sensor 524 installed at the front, left, right and rear of a vehicle, respectively, but the installation location of each sensor and the number of sensors installed are not limited to a specific embodiment. The processor 610 of the autonomous driving integrated controller 600 may determine a location (including a distance to a corresponding object), speed and moving direction of the corresponding object using a method of analyzing power of electromagnetic waves transmitted and received through the radar sensor 520.

The camera sensor 530 may detect a surrounding object outside a vehicle by photographing the periphery of the vehicle, and may detect a surrounding object within a set distance, set vertical field of view and set horizontal field of view, which are predefined depending on its specifications. The camera sensor 530 may include a front camera sensor 531, a left camera sensor 532, a right camera sensor 533 and a rear camera sensor 534 installed at the front, left, right and rear of a vehicle, respectively, but the installation location of each sensor and the number of sensors installed are not limited to a specific embodiment. The processor 610 of the autonomous driving integrated controller 600 may determine a location (including a distance to a corresponding object), speed and moving direction of the corresponding object by applying predefined image processing to an image captured by the camera sensor 530. Furthermore, an internal camera sensor 535 for photographing the inside of a vehicle may be mounted at a given location (e.g., rear view mirror) within the vehicle. The processor 610 of the autonomous driving integrated controller 600 may monitor a behavior and state of a passenger based on an image captured by the internal camera sensor 535, and may output guidance or a warning to the passenger through the output unit 300.

As illustrated in FIG. 1, the sensor unit 500 may further include an ultrasonic sensor 540 in addition to the LIDAR sensor 510, the radar sensor 520 and the camera sensor 530, and may further adopt various types of sensors for detecting a surrounding object of a vehicle along with the sensors. FIG. 3 illustrates an example in which in order to help understanding of the present embodiment, the front LIDAR sensor 511 or the front radar sensor 521 has been installed at the front of a vehicle, the rear LIDAR sensor 513 or the rear radar sensor 524 has been installed at the rear of the vehicle, and the front camera sensor 531, the left camera sensor 532, the right camera sensor 533 and the rear camera sensor 534 have been installed at the front, left, right and rear of the vehicle, respectively. However, as described above, the installation location of each sensor and the number of sensors installed are not limited to a specific embodiment. FIG. 5 illustrates an example of a set distance and horizontal field of view within which the LIDAR sensor 510, the radar sensor 520 and the camera sensor 530 may detect a surrounding object ahead of the vehicle. FIG. 6 illustrates an example in which each sensor detects a surrounding object. FIG. 6 is merely an example of the detection of a surrounding object. A method of detecting a surrounding object is determined by the installation location of each sensor and the number of sensors installed. A surrounding vehicle and a surrounding object in the omni-directional area of an ego vehicle being autonomously driven may be detected depending on a configuration of the sensor unit 500.

Furthermore, in order to determine a state of a passenger within a vehicle, the sensor unit 500 may further include a microphone and bio sensor for detecting a voice and bio signal (e.g., heart rate, electrocardiogram, respiration, blood pressure, body temperature, electroencephalogram, hotoplethysmography (or pulse wave) and blood sugar) of the passenger. The bio sensor may include a heart rate sensor, an electrocardiogram sensor, a respiration sensor, a blood pressure sensor, a body temperature sensor, an electroencephalogram sensor, a photoplethysmography sensor and a blood sugar sensor.

FIG. 4 illustrates an example of an internal structure of a vehicle. An internal device whose state is controlled by a manipulation of a passenger, such as a driver or fellow passenger of a vehicle, and which supports driving or convenience (e.g., rest or entertainment activities) of the passenger may be installed within the vehicle. Such an internal device may include a vehicle seat S in which a passenger is seated, a lighting device L such as an internal light and a mood lamp, the user terminal 120, the display 320, and an internal table. The state of the internal device may be controlled by the processor 610.

The angle of the vehicle seat S may be adjusted by the processor 610 (or by a manual manipulation of a passenger). If the vehicle seat S is configured with a front row seat S1 and a back row seat S2, only the angle of the front row seat S1 may be adjusted. If the back row seat S2 is not provided and the front row seat S1 is divided into a seat structure and a footstool structure, the front row seat S1 may be implemented so that the seat structure of the front row seat S1 is physically separated from the footstool structure and the angle of the front row seat S1 is adjusted. Furthermore, an actuator (e.g., motor) for adjusting the angle of the vehicle seat S may be provided. The on and off of the lighting device L may be controlled by the processor 610 (or by a manual manipulation of a passenger). If the lighting device L includes a plurality of lighting units such as an internal light and a mood lamp, the on and off of each of the lighting units may be independently controlled. The angle of the user terminal 120 or the display 320 may be adjusted by the processor 610 (or by a manual manipulation of a passenger) based on an angle of field of a passenger. For example, the angle of the user terminal 120 or the display 320 may be adjusted so that a screen thereof is placed in a passenger's gaze direction. In this case, an actuator (e.g., motor) for adjusting the angle of the user terminal 120 and the display 320 may be provided.

As illustrated in FIG. 1, the autonomous driving integrated controller 600 may communicate with a server 700 over a network. Various communication methods, such as a wide area network (WAN), a local area network (LAN) or a personal area network (PAN), may be adopted as a network method between the autonomous driving integrated controller 600 and the server 700. Furthermore, in order to secure wide network coverage, a low power wide area network (LPWAN, including commercialized technologies such as LoRa, Sigfox, Ingenu, LTE-M and NB-IOT, that is, networks having very wide coverage, among the IoT) communication method may be adopted. For example, a LoRa (capable of low power communication and also having wide coverage of a maximum of about 20 Km) or Sigfox (having coverage of 10 Km (downtown) to 30 Km (in the outskirt area outside the downtown area) according to environments) communication method may be adopted. Furthermore, LTE network technologies based on 3^{rd} generation partnership project (3GPP) Release 12, 13, such as machine-type communications (LTE-MTC) (or LTE-M), narrowband (NB) LTE-M, and NB IoT having a power saving mode (PSM), may be adopted. The server 700 may provide the latest map information (may correspond to various types of map information, such as two-dimensional (2-D) navigation map data, three-dimensional (3-D) manifold map data or 3-D high-precision electronic map data). Furthermore, the server 700 may provide various types of information, such as accident information, road control information, traffic volume information and weather information in a road. The autonomous driving integrated controller 600 may update map information, stored in the memory 620, by receiving the latest map information from the server 700, may receive accident information, road control information, traffic volume information and weather information, and may use the information for autonomous driving control of a vehicle.

The structure and functions of the autonomous driving integrated controller 600 according to the present embodiment are described with reference to FIG. 2. As illustrated in FIG. 2, the autonomous driving integrated controller 600 may include the processor 610 and the memory 620.

The memory 620 may store basic information necessary for autonomous driving control of a vehicle or may store information generated in an autonomous driving process of a vehicle controlled by the processor 610. The processor 610 may access (or read) information stored in the memory 620, and may control autonomous driving of a vehicle. The memory 620 may be implemented as a computer-readable recording medium, and may operate in such a way to be accessed by the processor 610. Specifically, the memory 620 may be implemented as a hard drive, a magnetic tape, a memory card, a read-only memory (ROM), a random access memory (RAM), a digital video disc (DVD) or an optical data storage, such as an optical disk.

The memory 620 may store map information that is required for autonomous driving control by the processor 610. The map information stored in the memory 620 may be a navigation map (or a digital map) that provides information of a road unit, but may be implemented as a precise road map that provides road information of a lane unit, that is, 3-D high-precision electronic map data, in order to improve the precision of autonomous driving control. Accordingly, the map information stored in the memory 620 may provide dynamic and static information necessary for autonomous driving control of a vehicle, such as a lane, the center line of a lane, an enforcement lane, a road boundary, the center line of a road, a traffic sign, a road mark, the shape and height of a road, and a lane width.

Furthermore, the memory 620 may store the autonomous driving algorithm for autonomous driving control of a vehicle. The autonomous driving algorithm is an algorithm (recognition, determination and control algorithm) for recognizing the periphery of an autonomous vehicle, determining the state of the periphery thereof, and controlling the driving of the vehicle based on a result of the determination. The processor 610 may perform active autonomous driving control for a surrounding environment of a vehicle by executing the autonomous driving algorithm stored in the memory 620.

The processor 610 may control autonomous driving of a vehicle based on the driving information and the traveling information received from the driving information input interface 101 and the traveling information input interface 201, respectively, the information on a surrounding object detected by the sensor unit 500, and the map information and the autonomous driving algorithm stored in the memory 620. The processor 610 may be implemented as an embedded processor, such as a complex instruction set computer (CICS) or a reduced instruction set computer (RISC), or a dedicated semiconductor circuit, such as an application-specific integrated circuit (ASIC).

In the present exemplary embodiment, the processor 610 may control autonomous driving of an ego vehicle being autonomously driven by analyzing the driving trajectory of each of the ego vehicle being autonomously driven and a surrounding vehicle. To this end, the processor 610 may include a sensor processing module 611, a driving trajectory generation module 612, a driving trajectory analysis module 613, a driving control module 614, a passenger state determination module 616 and a trajectory learning module 615, as illustrated in FIG. 2. FIG. 2 illustrates each of the modules as an independent block based on its function, but the modules may be integrated into a single module and implemented as an element for integrating and performing the functions of the modules.

The sensor processing module 611 may determine traveling information of a surrounding vehicle (i.e., includes the location of the surrounding vehicle, and may further include the speed and moving direction of the surrounding vehicle along the location) based on a result of detecting, by the sensor unit 500, the surrounding vehicle around an ego vehicle being autonomously driven. That is, the sensor processing module 611 may determine the location of a surrounding vehicle based on a signal received through the LIDAR sensor 510, may determine the location of a surrounding vehicle based on a signal received through the radar sensor 520, may determine the location of a surrounding vehicle based on an image captured by the camera sensor 530, and may determine the location of a surrounding vehicle based on a signal received through the ultrasonic sensor 540. To this end, as illustrated in FIG. 1, the sensor processing module 611 may include a LIDAR signal processing module 611a, a radar signal processing module 611b and a camera signal processing module 611c. In some embodiments, an ultrasonic signal processing module (not illustrated) may be further added to the sensor processing module 611. An implementation method of the method of determining the location of a surrounding vehicle using the LIDAR sensor 510, the radar sensor 520 and the camera sensor 530 is not limited to a specific embodiment. Furthermore, the sensor processing module 611 may determine attribute information, such as the size and type of a surrounding vehicle, in addition to the location, speed and moving direction of the surrounding vehicle. An algorithm for determining information, such as the location, speed, moving direction, size and type of a surrounding vehicle, may be predefined.

The driving trajectory generation module 612 may generate an actual driving trajectory and expected driving trajectory of a surrounding vehicle and an actual driving trajectory of an ego vehicle being autonomously driven. To this end, as illustrated in FIG. 2, the driving trajectory generation module 612 may include a surrounding vehicle driving trajectory generation module 612a and a vehicle-being-autonomously-driven driving trajectory generation module 612b.

First, the surrounding vehicle driving trajectory generation module 612a may generate an actual driving trajectory of a surrounding vehicle.

Specifically, the surrounding vehicle driving trajectory generation module 612a may generate an actual driving trajectory of a surrounding vehicle based on traveling information of the surrounding vehicle detected by the sensor unit 500 (i.e., the location of the surrounding vehicle determined by the sensor processing module 611). In this case, in order to generate the actual driving trajectory of the surrounding vehicle, the surrounding vehicle driving trajectory generation module 612a may refer to map information stored in the memory 620, and may generate the actual driving trajectory of the surrounding vehicle by making cross reference to the location of the surrounding vehicle detected by the sensor unit 500 and a given location in the map information stored in the memory 620. For example, when a surrounding vehicle is detected at a specific point by the sensor unit 500, the surrounding vehicle driving trajectory generation module 612a may specify a currently detected location of the surrounding vehicle in map information stored in the memory 620 by making cross reference to the detected location of the surrounding vehicle and a given location in the map information. The surrounding vehicle driving trajectory generation module 612a may generate an actual driving trajectory of a surrounding vehicle by continuously monitoring the location of the surrounding vehicle as described above. That is, the surrounding vehicle driving trajectory generation module 612a may generate an actual driving trajectory of a surrounding vehicle by mapping the location of the surrounding vehicle, detected by the sensor unit 500, to a location in map information, stored in the memory 620, based on the cross reference and accumulating the location.

An actual driving trajectory of a surrounding vehicle may be compared with an expected driving trajectory of the surrounding vehicle to be described later to be used to determine whether map information stored in the memory 620 is accurate. In this case, if an actual driving trajectory of a specific surrounding vehicle is compared with an expected driving trajectory, there may be a problem in that it is erroneously determined that map information stored in the memory 620 is inaccurate although the map information is accurate. For example, if actual driving trajectories and expected driving trajectories of multiple surrounding vehicles are the same and an actual driving trajectory and expected driving trajectory of a specific surrounding vehicle are different, when only the actual driving trajectory of the specific surrounding vehicle is compared with the expected driving trajectory, it may be erroneously determined that map information stored in the memory 620 is inaccurate although the map information is accurate. In order to prevent this problem, it is necessary to determine whether the tendency of actual driving trajectories of a plurality of surrounding vehicles gets out of an expected driving trajectory. To this end, the surrounding vehicle driving trajectory generation module 612a may generate the actual driving trajectory of each of the plurality of surrounding vehicles. Furthermore, if it is considered that a driver of a surrounding vehicle tends to slightly move a steering wheel left and right during his or her driving process for the purpose of straight-line path driving, an actual driving trajectory of the surrounding vehicle may be generated in a curved form, not a straight-line form. In order to compute an error between expected driving trajectories to be described later, the surrounding vehicle driving trajectory generation module 612a may generate an actual driving trajectory of a straight-line form by applying a given smoothing scheme to the original actual driving trajectory generated in a curved form. Various schemes, such as interpolation for each location of a surrounding vehicle, may be adopted as the smoothing scheme.

Furthermore, the surrounding vehicle driving trajectory generation module 612a may generate an expected driving trajectory of a surrounding vehicle based on map information stored in the memory 620.

As described above, the map information stored in the memory 620 may be 3-D high-precision electronic map data. Accordingly, the map information may provide dynamic and static information necessary for autonomous driving control of a vehicle, such as a lane, the center line of a lane, an enforcement lane, a road boundary, the center line of a road, a traffic sign, a road mark, a shape and height of a road, and a lane width. If it is considered that a vehicle commonly travels in the middle of a lane, it may be expected that a surrounding vehicle that travels around an ego vehicle being autonomously driven will also travel in the middle of a lane. Accordingly, the surrounding vehicle driving trajectory generation module 612a may generate an expected driving trajectory of the surrounding vehicle as the center line of a road incorporated into map information.

The vehicle-being-autonomously-driven driving trajectory generation module 612b may generate an actual driving trajectory of an ego vehicle being autonomously driven that has been driven so far based on the traveling information of the ego vehicle being autonomously driven obtained through the traveling information input interface 201.

Specifically, the vehicle-being-autonomously-driven driving trajectory generation module 612b may generate an actual driving trajectory of an ego vehicle being autonomously driven by making cross reference to a location of the ego vehicle being autonomously driven obtained through the traveling information input interface 201 (i.e., information on the location of the ego vehicle being autonomously driven obtained by the GPS receiver 260) and a given location in map information stored in the memory 620. For example, the vehicle-being-autonomously-driven driving trajectory generation module 612b may specify a current location of an ego vehicle being autonomously driven, in map information, stored in the memory 620, by making cross reference to a location of the ego vehicle being autonomously driven obtained through the traveling information input interface 201 and a given location in the map information. As described above, the vehicle-being-autonomously-driven driving trajectory generation module 612b may generate an actual driving trajectory of the ego vehicle being autonomously driven by continuously monitoring the location of the ego vehicle being autonomously driven. That is, the vehicle-being-autonomously-driven driving trajectory generation module 612b may generate the actual driving trajectory of the ego vehicle being autonomously driven by mapping the location of the ego vehicle being autonomously driven, obtained through the traveling information input interface 201, to a location in the map information stored in the memory 620, based on the cross reference and accumulating the location.

Furthermore, the vehicle-being-autonomously-driven driving trajectory generation module 612b may generate an expected driving trajectory up to the destination of an ego vehicle being autonomously driven based on map information stored in the memory 620.

That is, the vehicle-being-autonomously-driven driving trajectory generation module 612b may generate the expected driving trajectory up to the destination using a current location of the ego vehicle being autonomously driven obtained through the traveling information input interface 201 (i.e., information on the current location of the ego vehicle being autonomously driven obtained through the GPS receiver 260) and the map information stored in the memory 620. Like the expected driving trajectory of the surrounding vehicle, the expected driving trajectory of the ego vehicle being autonomously driven may be generated as the center line of a road incorporated into the map information stored in the memory 620.

The driving trajectories generated by the surrounding vehicle driving trajectory generation module 612a and the vehicle-being-autonomously-driven driving trajectory generation module 612b may be stored in the memory 620, and may be used for various purposes in a process of controlling, by the processor 610, autonomous driving of an ego vehicle being autonomously driven.

The driving trajectory analysis module 613 may diagnose current reliability of autonomous driving control for an ego vehicle being autonomously driven by analyzing driving trajectories (i.e., an actual driving trajectory and expected driving trajectory of a surrounding vehicle and an actual driving trajectory of the ego vehicle being autonomously driven) that are generated by the driving trajectory generation module 612 and stored in the memory 620. The diagnosis of the reliability of autonomous driving control may be performed in a process of analyzing a trajectory error between the actual driving trajectory and expected driving trajectory of the surrounding vehicle.

The driving control module 614 may perform a function for controlling autonomous driving of an ego vehicle being autonomously driven. Specifically, the driving control module 614 may process the autonomous driving algorithm synthetically using the driving information and the traveling information received through the driving information input interface 101 and the traveling information input interface 201, respectively, the information on a surrounding object detected by the sensor unit 500, and the map information stored in the memory 620, may transmit the control information to the low-ranking control system 400 through the vehicle control output interface 401 so that the low-ranking control system 400 controls autonomous driving of an ego vehicle being autonomously driven, and may transmit the driving state information and warning information of the ego vehicle being autonomously driven to the output unit 300 through the passenger output interface 301 so that a driver can recognize the driving state information and warning information. Furthermore, when integrating and controlling such autonomous driving, the driving control module 614 controls the autonomous driving by taking into consideration the driving trajectories of an ego vehicle being autonomously driven and a surrounding vehicle, which have been analyzed by the sensor processing module 611, the driving trajectory generation module 612 and the driving trajectory analysis module 613, thereby improving the precision of autonomous driving control and enhancing the safety of autonomous driving control.

The trajectory learning module 615 may perform learning or corrections on an actual driving trajectory of an ego vehicle being autonomously driven generated by the vehicle-being-autonomously-driven driving trajectory generation module 612b. For example, when a trajectory error between an actual driving trajectory and expected driving trajectory of a surrounding vehicle is a preset threshold or more, the trajectory learning module 615 may determine that an actual driving trajectory of an ego vehicle being autonomously driven needs to be corrected by determining that map information stored in the memory 620 is inaccurate. Accordingly, the trajectory learning module 615 may determine a lateral shift value for correcting the actual driving trajectory of the ego vehicle being autonomously driven, and may correct the driving trajectory of the ego vehicle being autonomously driven.

The passenger state determination module 616 may determine a state and behavior of a passenger based on a state and bio signal of the passenger detected by the internal camera sensor 535 and the bio sensor. The state of the passenger determined by the passenger state determination module 616 may be used for autonomous driving control of an ego vehicle being autonomously driven or in a process of outputting a warning to the passenger.

An exemplary embodiment in which a target object is detected and tracked through the sensor unit 500 applied to an ego vehicle being autonomously driven is described below based on the aforementioned contents.

The processor 610 according to the present exemplary embodiment may control autonomous driving of an ego vehicle being autonomously driven based on a track indicative of the state trajectory of a target object around the ego vehicle being autonomously driven, which is estimated from a measurement value of the location of the ego vehicle being autonomously driven detected by the sensor unit 500, along with map information stored in the memory 620. A surrounding object, that is, a target to be tracked by the sensor unit 500, is indicated as the target object.

Specifically, in the present exemplary embodiment, the sensor processing module 611 of the processor 610 may track a target object based on a probabilistic data association filter (PDAF). The PDAF is based on the premise that a state value of a target object is updated based on a state equation and measurement equation of Equation 1 below.

x(k)=F(k−1)x(k−1)+v(k−1)

z(k)=H(k)x(k)+w(k) (1)

In Equation 1, x(k) indicates a state value (state vector) of a target object at a timing k. F(k−1) indicates a state shift matrix indicative of a change upon switching from timing k−1 to the timing k. z(k) indicates a measurement value of the location of the target object at the timing k. H(k) indicates a monitoring model for converting the state value of the target object into the measurement value of the location. v(k−1) and w(k) indicate process noise at the timing k−1 and measurement noise at the timing k, respectively. A white Gaussian distribution in which an average of noise is 0 and covariance has Q(k−1) and R(k) is applied.

Furthermore, the processor 610 may initialize the track of the target object based on a Kalman filter. The Kalman filter is a scheme for estimating an accurate location of an object by offsetting an error, occurring when the location of the object is measured, by repeatedly calculating an estimate of the location of the object based on an estimate of the location of the object and a measurement value of the location of the object at a previous timing. Specifically, first, the Kalman filter calculates an estimate at a current timing, based on only a measurement value up to a previous timing using an estimate of the location of the object up to the previous timing. Thereafter, the Kalman filter calculates an estimate of the location of the object at a current timing by correcting an estimate at the current timing, based on only the measurement value up to the previous timing, using covariance at the current timing, computed using only the measurement value up to the previous timing, and a measurement value of the location of the object at the current timing.

The processor 610 may initialize the track of the target object based on the Kalman filter according to Equation 2 below.

\hat{x}(k|k−1)=F(k−1)\hat{x}(k−1|k−1)

\hat{z}(k|k−1)=H(k)\hat{x}(k|k−1) (2)

In Equation 2, \hat{x}(k|k−1) indicates an estimate of a state value of a target object at timing k, estimated using information up to timing k−1. \hat{x}(k−1|k−1) indicates an estimate of a state value of the target object at the timing k−1, estimated using information up to the time k−1. \hat{z}(k|k−1) indicates an estimate of the location of the target object at the timing k, estimated using information up to the time k−1.

In a system for tracking a single object, the estimated error covariance matrix of a standard Kalman filter is computed as the covariance matrix of process noise and measurement noise, and is an index indicative of performance of a tracker. However, if a clutter is present, the estimated error covariance matrix of the tracker is no longer independent of a measurement value and becomes a function of measured data. Accordingly, in order to precisely and efficiently predict performance of the tracker, an approximated covariance matrix capable of properly representing the performance of the tracker needs to be obtained. In this regard, in the present embodiment, the configuration of a Kalman filter for the tracking of a target object may be represented like Equation 3 below.

$$\begin{matrix}P ( k \vert k ) = \text{?} β ( k , i ) [ P ( k \vert k , i ) + ( \hat{x} ( k \vert k , i ) - \hat{x} ( k \vert k ) ) {( \hat{x} ( k \vert k , i ) - \hat{x} ( k \vert k ) )}^{T} ] & ( 3 ) \\ P ( k \vert k - 1 ) = F ( k - 1 ) P ( k - 1 \vert k - 1 ) {F ( k - 1 )}^{T} + Q ( k - 1 ) & \\ \text{?} \text{indicates text missing or illegible when filed} & \end{matrix}$$

In Equation 3, P(k|k) indicates covariance of an estimated error of the Kalman filter at timing k, computed by taking into consideration information up to the time k. P(k|k−1) indicates covariance of an estimated error of the Kalman filter at the timing k, computed by taking into consideration information up to timing k−1. Q(k−1) indicates expected covariance at the timing k−1.

Accordingly, the processor 610 may extract one or more valid measurement values that belong to one or more measurement values output by the sensor unit 500 (i.e., measurement values of locations obtained by detecting all objects around an ego vehicle being autonomously driven including the target object) and that are present within the validation gate of an estimate of the location of the target object generated from a measurement value of the location of the target object. In this case, the processor 610 may extract the valid measurement values by determining whether a Mahalanobis distance determined based on an innovation between the measurement value and an estimate of the location of the target object and covariance of the innovation is less than a threshold that determines the size of the validation gate. The innovation and the covariance of the innovation may be derived according to Equation 4 below.

v(k,i)=z(k,i)−\hat{z}(k|k−1)

S(k)=H(k)P(k|k−1)H(k)^{r}+R(k) (4)

In Equation 4, v(k,i) indicates an innovation of an object i at timing k. z(k,i) indicates a measurement value of the location of the object i. \hat{z}(k|k−1) is an estimate of the location of the target object at the timing k, estimated using information up to timing k−1. S(k) is covariance of the innovation. R(k) indicates measurement noise at the timing k.

Accordingly, the processor 610 may calculate a Mahalanobis distance based on the innovation and covariance of the innovation computed through Equation 4, may determine whether the calculated distance is less than a threshold that determines the size of the validation gate, and may extract one or more valid measurement values. This may be represented like Equation 5 below.

v(k,i)^{r}S(k)⁻¹v(k,i)<γ (5)

In Equation 5, r indicates the threshold that determines the size of the validation gate. A set of valid measurement values extracted through Equation 5 may be represented like {z(k,i)}ᵢ₌₁^{m(k)}.

In this case, the processor 610 may extract the valid measurement values by adjusting the size of the validation gate based on the time during which the target object is tracked and surrounding environment information of an ego vehicle being autonomously driven. That is, the processor 610 may extract the valid measurement values using a method of adjusting the threshold that determines the size of the validation gate.

A process of adjusting the size of the threshold is described below. The processor 610 may decrease the size of the validation gate by decreasing the threshold according to an increase in the time period during which the tracking of a target object is maintained.

That is, if the target object continues to be tracked and the reliability of the tracking is at a given level or more, the processor 610 may operate to prioritize an operation of reducing a computational load necessary to extract a valid measurement value and to generate the track of the target object by decreasing measurement values within a validation gate. Accordingly, the processor 610 may decrease the size of the validation gate by decreasing the threshold according to an increase in the time period during which the tracking of the target object is maintained.

Furthermore, the processor 610 may increase or decrease the size of the validation gate by adjusting the threshold using an environment weight into which a degree of tracking caution based on surrounding environment information has been incorporated. In this case, the surrounding environment information may include one or more of a shape (e.g., curvature, gradient) of a front road, attributes (e.g., type, general road/crossroad, speed limit and children protection zone), traffic conditions (e.g., traffic volume and travel speed) and road conditions (e.g., paved/unpaved road and the number of pedestrians).

Specifically, the processor 610 may obtain the surrounding environment information through the user terminal 120 or the sensor unit 500, and may determine a degree of tracking caution based on the obtained surrounding environment information. In this case, the degree of tracking caution may mean a parameter indicative of uneasiness for the tracking of a target object depending on a surrounding environment of an ego vehicle being autonomously driven. It may be said that the degree of tracking caution is higher if it is difficult to track a target object because a surrounding environment is under poor conditions.

Accordingly, if it is determined that it is difficult to track a target object based on surrounding environment information (e.g., when a degree of tracking caution is high), the processor 610 may increase the size of a threshold by increasing an environment weight so that the size of a validation gate is increased, in order to improve the reliability of the tracking of the target object. In contrast, if it is determined that it is easy to track a target object based on surrounding environment information (e.g., when a degree of tracking caution is low), the processor 610 may decrease the size of a threshold by decreasing an environment weight so that the size of a validation gate is decreased, in order to reduce a computational load necessary for the tracking of the target object. For example, if curvature of a front road is great, in the case of a crossroad, in the case of a children protection zone, if a traffic volume is great, and if the number of pedestrians is great, a degree of tracking caution may be considered to be high. Accordingly, the processor 610 may increase the size of a threshold by increasing an environment weight so that the size of a validation gate is increased.

Mapping information between the surrounding environment information and the environment weight may be stored in the memory 620 in the form of a lookup table. Accordingly, the processor 610 may determine a threshold by extracting, from the mapping information, current environment information mapped to driving environment information.

To adjust the threshold based on the time period during which the tracking of the target object is tracked and surrounding environment information of the ego vehicle being autonomously driven may be performed based on Equation 6 below.

$$r = α ( \frac{{D}_{T} - {T}_{T}}{{D}_{T}} ) {r}_{0} \qquad ( 6 )$$

In Equation 6, α indicates a weight based on surrounding environment information. D_{T} is a predefined time constant. r₀ is a predefined initial value of a threshold. T_{T} indicates the time period during which the tracking of a target object is maintained, i.e., the time during which tracking continues without missing the target object.

When the valid measurement values are extracted, the processor 610 may form the track of the target object by taking into consideration the probability that each of the extracted valid measurement values will correspond to a measurement value of the location of the target object at a current timing, and may track the target object. This may be represented by Equation 7 below.

$$β ( k , i ) = \{ \begin{matrix}\frac{{ℒ}_{i} ( k )}{1 - {P}_{D} {P}_{G} + {\sum }_{j = 1}^{m ( k )} ℒ ( k , j )} , & i = 1 , … , m ( k ) \\ \frac{1 - {P}_{D} {P}_{G}}{1 - {P}_{D} {P}_{G} + {\sum }_{j = 1}^{m ( k )} ℒ ( k , j )} , & i = 0 ,\end{matrix} \\ ℒ ( k , i ) {=}^{Δ} \frac{𝒩 [ z ( k , i ) ; \hat{z} ( k \vert k - 1 ) , S ( k ) ] {P}_{D}}{λ} \qquad ( 7 )$$

In Equation 7, P_{D} indicates a predefined target object detection probability. P_{G} indicates a gate probability. L(k,i) indicates a likelihood ratio that a valid measurement value z(k,i) will be caused from the target object, not a clutter.

Thereafter, the processor 610 may update the track using a method of updating an estimate of the location of the target object over time, may store a history, in which the track is updated, in the memory 620, and may perform track management through the initialization of the track.

Specifically, the processor 610 may calculate a Kalman gain for updating the estimate of the location of the target object, based on covariance of an estimated error and covariance of the innovation, and may calculate an estimate of the location, estimated using information up to a current timing, based on the Kalman gain, a measurement value of the location of the target object, and an estimate of the location of the target object estimated using information up to a previous timing. The update of the estimate of the location of the target object may be represented by Equation 8 below.

$$\begin{matrix} K ( k ) = P ( k \vert k - 1 ) \text{?} {S ( k )}^{- 1} & ( 8 ) \\ \hat{x} ( k \vert k , i ) = \{ \begin{matrix}\hat{x} ( k \vert k - 1 ) & i = 0 \\ \hat{x} ( k \vert k - 1 ) + K ( k ) v ( k , i ) & i > 0\end{matrix} & \\ \hat{x} ( k \vert k ) = \text{?} β ( k , i ) \hat{x} ( k \vert k , i ) & \\ \text{?} \text{indicates text missing or illegible when filed} & \end{matrix}$$

In Equation 8, K(k) indicates the Kalman gain. A more accurate location estimate can be obtained by updating the location estimate by taking into consideration a measurement value of the location of a target object over time as described above, and thus the accuracy of the update of a track can be improved.

The processor 610 may store, in the memory 620, the history in which the track is updated. The history stored in the memory 620 may include an estimate and measurement value of a location for the Kalman filter at each timing and covariance of an estimated error of the Kalman filter.

If an estimate of the location of a target object is updated, objects indicated by two tracks may collide against each other in some cases. When a difference between the estimates of the locations of the objects indicated by the respective tracks is less than a previously stored reference value, the processor 610 may determine that the objects indicated by the two tracks collide against each other, and may initialize the tracks based on data included in the histories of the respective tracks.

Furthermore, if estimates of the locations of all objects included in tracks are not included in the region of a validation gate corresponding to the tracks, the processor 610 may initialize the tracks based on the histories of the tracks stored in the memory 620. That is, if an object tracked by a track disappears because all the objects tracked by the tracks deviate from the validation gate or are determined as noise or errors, this means that tracking an object has failed. Accordingly, the processor 610 may initialize the tracks and track a new object.

As described above, a track is generated using the Kalman filter, and a target object is tracked using the track. In this case, if the tracking of the target object using the track fails or two tracks collide against each other, the track is initialized and a new object is tracked. Accordingly, target object tracking performance can be improved.

The processor 610 may control autonomous driving of an ego vehicle being autonomously driven using data, included in a track generated and updated by tracking a target object as described above, so that the ego vehicle being autonomously driven avoids the target object through the low-ranking control system 400 or a warning is output to a passenger through the output unit 300.

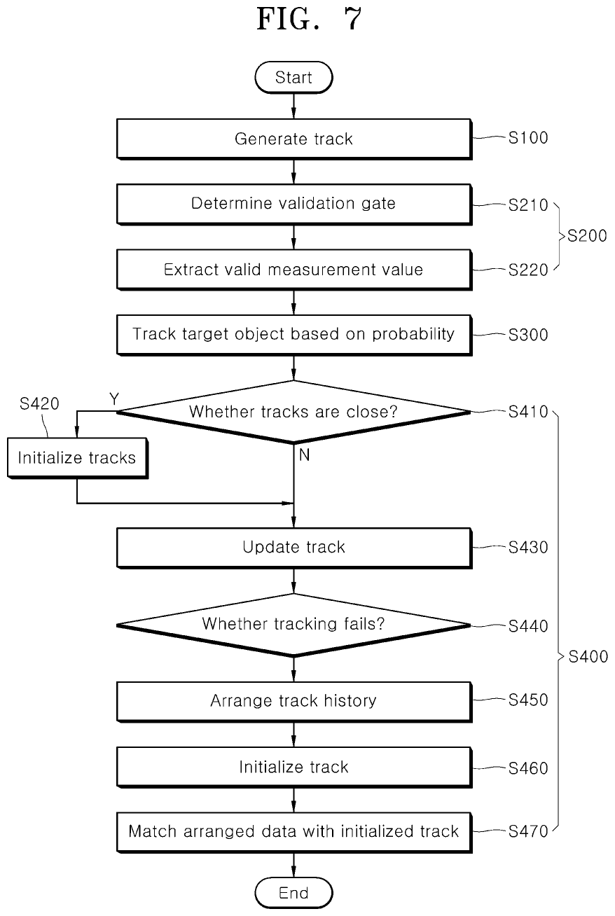

FIG. 7 is a flowchart for describing an autonomous driving method according to an embodiment of the present disclosure. The processor 610 may control autonomous driving of an ego vehicle being autonomously driven, based on map information stored in the memory 620 and a track indicative of a state trajectory of a target object around the ego vehicle being autonomously driven, estimated based on a measurement value of the location of the target object detected by the sensor unit 500 ego vehicle being autonomously driven.

To this end, first, the processor 610 generates (or initializes) a track of the target object based on the state equation and measurement equation of Equation 1 and the Kalman filter of Equation 2 (S100).

Next, the processor 610 extracts one or more valid measurement values that belong to one or more measurement values output by the sensor unit 500 and that are present within the validation gate of an estimate of the location of the target object generated based on the measurement values. (S200). At step S200, the processor 610 determines whether a Mahalanobis distance determined based on an innovation between a measurement value output by the sensor unit 500 and an estimate of the location of the target object and covariance of the innovation is less than a threshold that determines the size of a validation gate, and extracts the one or more valid measurement values.

At step S200, the processor 610 determines the validation gate, that is, a range in which the target object is detected (S210). In this case, the processor 610 adjusts the size of the validation gate based on the time period during which the tracking of the target object is maintained and surrounding environment information of the ego vehicle being autonomously driven. Specifically, the processor 610 increases the size of the validation gate by increasing the threshold according to an increase in the time period during which the tracking of the target object is maintained, and also increases or decreases the size of the validation gate by adjusting the threshold using an environment weight into which a degree of tracking caution based on surrounding environment information has been incorporated. The surrounding environment information may include one or more of a shape, attributes, traffic condition and road surface condition of a front road. Furthermore, the processor 610 extracts valid measurement values using the validation gate having a size adjusted based on the threshold (S220).

When the valid measurement values are extracted at step S200, the processor 610 forms a track of the target object by taking into consideration the probability that each of the extracted valid measurement values may correspond to a measurement value of the location of the target object at a current timing, and tracks the target object using the track (S300).

Next, the processor 610 updates the track using a method of updating an estimate of the location of the target object over time, stores a history, in which the track is updated, in the memory 620, and performs track management through the initialization of the track (S400).

At step S400, when a difference between estimates of the locations of target objects indicated by respective tracks is less than a previously stored reference value (S410), the processor 610 determines that the tracks are close each other and initializes the tracks based on data included in the history of each track (S420).

When the difference between the estimates of the locations of the target objects indicated by the respective tracks is the previously stored reference value or more (S410), the processor 610 updates a track using an updated estimate of the location of a target object (S430). Furthermore, if the tracking of a target object fails (S440) (i.e., if estimates of the locations of all objects included in the tracks are not included in the region of the validation gate corresponding to the tracks), the processor 610 arranges data that has been stored in the memory 620 and that corresponds to the history of the track of the target object for which tracking has failed (S450), and initializes the corresponding track (S460). Next, the processor 610 matches the data, arranged at step S450, with the track (i.e., initialized track) of the target object for which tracking has failed (S470). The processor 610 may maintain only data that belongs to arranged data and that may be used to track a new object, so that the new object is tracked based on the data. If the tracking of the target object is successful at step S440, the target object maintains a current track, and the process is terminated.

As described above, according to the present embodiment, a target object to be detected can be accurately identified and tracked using a method of dynamically adjusting a validation gate for detecting the target object when the target object is detected and tracked using a sensor mounted on the autonomous vehicle.

Although exemplary embodiments of the present invention have been disclosed for illustrative purposes, those skilled in the art will appreciate that various modifications, additions and substitutions are possible, without departing from the scope and spirit of the present invention as defined in the accompanying claims. Thus, the true technical scope of the present invention should be defined by the following claims.

What is claimed is:

1. An autonomous driving apparatus comprising:
a sensor unit configured to detect a target object around an ego vehicle being autonomously driven;
a memory configured to store map information; and
a processor configured to control autonomous driving of the ego vehicle being autonomously driven, based on the map information stored in the memory and a track indicative of a state trajectory of the target object estimated based on a measurement value of a location of the target object detected by the sensor unit,
wherein the processor is configured to:
extract one or more valid measurement values within a validation gate of an estimate of the location of the target object, generated based on the measurement value of the location, among one or more measurement values output by the sensor unit;
form a track of the target object by taking into consideration a probability that each of the extracted valid measurement values corresponds to a measurement value of the location of the target object at a current timing and track the target object using the track; and
extract the valid measurement values by adjusting a size of the validation gate based on a time period during which the tracking of the target object is maintained and surrounding environment information of the ego vehicle being autonomously driven.

2. The autonomous driving apparatus of claim 1, wherein the processor is configured to:
determine whether a Mahalanobis distance determined based on an innovation between the measurement value and the estimate of the location of the target object and covariance of the innovation is less than a threshold to determine the size of the validation gate; and
extract the valid measurement values.

3. The autonomous driving apparatus of claim 2, wherein the processor is configured to decrease the size of the validation gate by reducing the threshold according to an increase in the time period during which the tracking of the target object is maintained.

4. The autonomous driving apparatus of claim 2, wherein:
the processor is configured to increase or decrease the size of the validation gate by adjusting the threshold using an environment weight into which a degree of tracking caution based on the surrounding environment information has been incorporated; and
the surrounding environment information comprises at least one of a shape, attributes, a traffic condition, and a road surface condition of a front road.

5. The autonomous driving apparatus of claim 1, wherein the processor is configured to:
update the track using a method of updating the estimate of the location of the target object over time;
store, in the memory, a history in which the track is updated; and
perform track management through an initialization of the track.

6. The autonomous driving apparatus of claim 1, wherein the sensor unit comprises at least one of a LIDAR sensor, a radar sensor, and a camera sensor.

7. A method of controlling autonomous driving of an ego vehicle being autonomously driven, wherein a processor controls autonomous driving of the ego vehicle being autonomously driven based on map information stored in a memory and a track indicative of a state trajectory of a target object around the ego vehicle being autonomously driven, estimated based on a measurement value of a location of the target object detected by a sensor unit, the method comprising:
extracting, by the processor, one or more valid measurement values within a validation gate of an estimate of the location of the target object, generated based on the measurement value of the location, among one or more measurement values output by the sensor unit; and
forming, by the processor, a track of the target object by taking into consideration a probability that each of the extracted valid measurement values corresponds to a measurement value of the location of the target object at a current timing and tracking the target object using the track,
wherein in the extracting of the one or more valid measurement values, the processor extracts the valid measurement values by adjusting a size of the validation gate based on time period during which the tracking of the target object is maintained and surrounding environment information of the ego vehicle being autonomously driven.

8. The method of claim 7, wherein in the extracting of the one or more valid measurement values, the processor determines whether a Mahalanobis distance determined based on an innovation between the measurement value and the estimate of the location of the target object and covariance of the innovation is less than a threshold to determine the size of the validation gate, and extracts the valid measurement values.

9. The method of claim 8, wherein in the extracting of the one or more valid measurement values, the processor decreases the size of the validation gate by reducing the threshold according to an increase in the time period during which the tracking of the target object is maintained.

10. The method of claim 8, wherein:
in the extracting of the one or more valid measurement values, the processor increases or decreases the size of the validation gate by adjusting the threshold using an environment weight into which a degree of tracking caution based on the surrounding environment information has been incorporated; and
the surrounding environment information comprises at least one of a shape, attributes, a traffic condition, and a road surface condition of a front road.

11. The method of claim 7, further comprising:
updating, by the processor, the track using a method of updating the estimate of the location of the target object over time;
storing, in the memory, a history in which the track is updated; and
performing track management through an initialization of the track.
